(19) United States
(12) Patent Application Publication
(10) Pub. No.: US 2016/0285292 A1
(43) Pub. Date: Sep. 29, 2016

(54) Portable Electronic Device Case Assembly

(71) Applicant: Karen OConnor, Santa Rosa, CA (US)

(72) Inventor: Karen OConnor, Santa Rosa, CA (US)

(21) Appl. No.: 15/082,438

(22) Filed: Mar. 28, 2016

Related U.S. Application Data
(60) Provisional application No. 62/138,737, filed on Mar. 26, 2015.

(51) Int. Cl. H02J 7/00

(52) U.S. Cl. CPC H02J 7/0044

(57) ABSTRACT

A portable electronic device case assembly is provided that includes a device mount, a device case, and a retractable tether therebetween. The device mount is a body-worn support that includes a receptacle for supporting the device case, a battery power supply, and a tether spool. The device case is a support for a handheld electronic device that is adapted to fit within the interior of the device mount. The tether is supported on the tether spool and is used to connect the device mount to the device case. When the device case is supported within the device mount, an electrical connector couples to the portable electronic device in order to power the battery thereof. Several embodiments are disclosed, including a device mount with a pivotable electrical connector, a two-part device mount to assist receiving the device case, as well as various connection methods between the device case and device mount.

### CROSS REFERENCE TO RELATED APPLICATION

This application claims the benefit of U.S. Provisional Application No. 62/138,737 filed on Mar. 26, 2015. The above identified patent application is herein incorporated by reference in its entirety to provide continuity of disclosure.

### BACKGROUND OF THE INVENTION

1. Field of the Invention

The present invention relates to protective cases for portable electronic devices. More specifically, the present invention relates to a protective case assembly that includes a body-worn device mount, a device case, and a retractable tether therebetween. The device mount supports a retractable tether spool to prevent the device case from falling, and a battery power supply to charge the electronic device supported within the case when the case is coupled to the device mount.

Smartphones and other electronic devices are now ubiquitous in modern life. These devices provide communication capabilities and convenient access to information. Their use is so prevalent that users handle and interrogate their smartphones on a regular basis, whereby the device is used consistently throughout the day. This frequent handling can lead to mishandling. It is common for smartphones and other electronic devices to be dropped, which can result in damage to the device.

Most solutions to this problem involve a protective case around the chassis of the device. However, device cases are not completely reliable for protecting the integrity of the device, and particularly the screen of the device. High energy contact with a hard surface can still cause damage to the device, resulting in repair or replacement expenses. The present invention provides an improved electronic device case that involves a device mount and a device case. The device case supports the electronic device, while the device mount is body-worn. A tether therebetween ensures the device will not be dropped on the floor while in use.

In addition, the tether of the assembly prevents snatch-and-grab theft while handling the device. That is, the tether prevents someone from swiping a user's device from his or her hands and stealing the same. The assembly of the present invention also provides a charging feature, which can be used to charge the battery of the device using a power supply within the interior of the device mount. When the device case is received within the device mount, an electrical connector couples to the electronic device and charges the batter thereof. Since the battery is disposed on the device mount, the battery size and weight does not affect the handling of the electronic device because the device case and the device mount are separable when the user engages the electronic device. Overall, the present invention provides a new, multi-function device case assembly.

### SUMMARY OF THE INVENTION

The following summary is intended solely for the benefit of the reader and is not intended to be limiting in any way. The present invention provides a new portable electronic device case assembly that can be utilized for protecting a portable electronic device and charging the device.

It is therefore an object of the present invention to provide a new and improved portable electronic device case assembly that has all of the advantages of the prior art and none of the disadvantages.

It is another object of the present invention to provide a portable electronic device case assembly that comprises a device mount, a device case, and a retractable tether therebetween. The device mount is body-worn, while the device case supports and surrounds a portable electronic device.

Another object of the present invention is to provide a portable electronic device case assembly wherein the device mount has a substantially rectangular shape with upstanding sidewalls, an open front surface, an interior surface, and a rear wall.

Another object of the present invention is to provide a portable electronic device case assembly wherein the device case comprises a substantially rectangular shape. The upstanding sidewalls, interior surface, and open front surface of the device mount form a receptacle adapted to receive the device case therein.

Another object of the present invention is to provide a portable electronic device case assembly wherein the tether extends between a lower end of the device mount and a lower end of the device case. The tether is supported on a retractable spool within an enclosure disposed within the device mount, the enclosure being disposed between the interior surface and the rear wall of the device mount.

Another object of the present invention is to provide a portable electronic device case assembly further comprising a battery power supply disposed within the device mount and an electrical connector.

Another object of the present invention is to provide a portable electronic device case assembly wherein the electrical connector is adapted to couple to the portable electronic device when the portable electronic device is supported by the device case and when the device case is positioned within the device mount.

Another object of the present invention is to provide a portable electronic device case assembly wherein the connector is electrically connected to the battery power supply of the device mount and the electrical connecter is disposed along the lower end of the device mount.

Another object of the present invention is to provide a portable electronic device case assembly wherein the retractable spool further comprises a spool and a return spring to bias the spool. The return spring biases the spool so the tether is tensioned and biased to return on the spool. Additionally, the spool may further comprise a ratchet and pawl mechanism to operably lock the spool in a static state when the tether is extended.

Another object of the present invention is to provide a portable electronic device case assembly in which the battery power supply is disposed between the interior surface and the rear wall of the device mount.

Another object of the present invention is to provide a portable electronic device case assembly wherein the device mount has an upper half and a lower half. The upper half and lower half are removably connected along a line of connection to facilitate placement of the device case within the receptacle of the device mount and to facilitate connection of the portable electronic device to the electrical connector.

Another object of the present invention is to provide a portable electronic device case assembly wherein the electrical connector is pivotably mounted along the lower end of the device mount to facilitate connection of the portable electronic device to the electrical connector when the device case is positioned within the receptacle of the device mount.

Another object of the present invention is to provide a portable electronic device case assembly wherein the device mount further comprises lateral tabs along the upstanding sidewalls thereof. The lateral tabs extend inward along the open front surface of the device mount and are adapted to be positioned over the device case, securing the device case within the receptacle of the device mount when the device case is positioned therein.

Another object of the present invention is to provide a portable electronic device case assembly wherein the device mount further comprises hook and loop fastener material along the interior surface thereof. The device case further comprises corresponding hook and loop fastener material along a rear wall of the device case. The hook and loop material of the device mount and the hook and loop material of the device case are adapted to align and connect when the device case is positioned within the receptacle of the device mount.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an embodiment of the portable electronic device case assembly of the present invention.

FIG. 2 shows another embodiment of the portable electronic device case assembly of the present invention.

FIG. 3 shows a two-part embodiment of the device mount.

FIG. 4 shows an embodiment of the electrical connector of the device mount.

FIG. 5 shows a view of the device case received within the interior of the device mount.

FIG. 6 shows a cross section view of the device mount.

FIG. 7 shows a view of the portable electronic device case assembly of the present invention in a working state.

### DETAILED DESCRIPTION OF THE INVENTION

Reference is made herein to the attached drawings. Like reference numerals are used throughout the drawings to depict like or similar elements of the portable electronic device case assembly of the present invention. For the purposes of presenting a brief and clear description of the present invention, the preferred embodiment will be discussed as used for supporting a portable electronic device case, tethering the same to the user, and charging the electronic device when the device is not in use. The figures are intended for representative purposes only and should not be considered to be limiting in any respect.

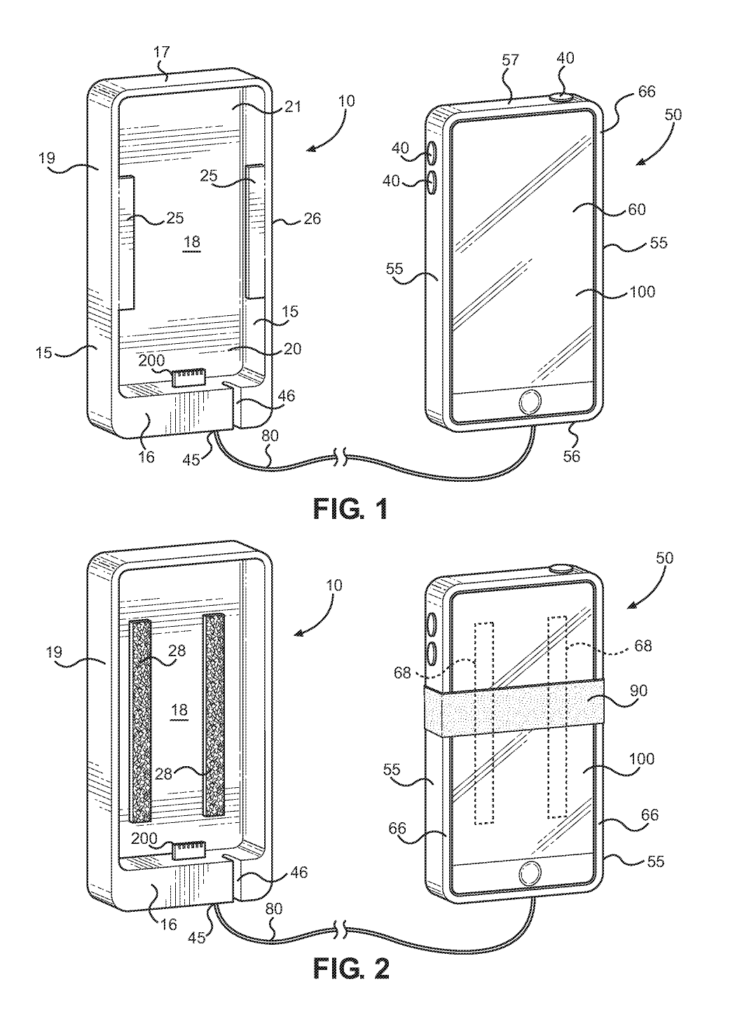

The present invention is a multi-use portable electronic device case that tethers a portable electronic device 100 to the user and charges the same while not in use. Referring to FIGS. 1 and 2, the portable electronic device case is an assembly comprising a device mount 10, a device case 50, and a tether 80 extending therebetween. Various embodiments are provided for the device mount 10 and device case 50. The device mount 10 is a body-worn structure having a substantially rectangular shape with upstanding sidewalls 15, an open front surface 20, an interior surface 18, and a rear wall 19. The upstanding sidewalls 15, interior surface 18, and open front surface 20 of the device mount 10 form a receptacle 21 adapted to receive the device case 50. The receptacle 21 is an open volume sized to receive the device case 50 therein, whereby the device case 50 is supported by the device mount 10 when mounted within the receptacle 21.

The device case 50 is a protective case around a portable electronic device that is sized to be received within the receptacle 21 of the device mount 10. The device case 50 supports a portable electronic device 100, whereby the device case 50 further comprises a substantially rectangular shape. The device case 50 comprises a plurality of sidewalls that surround the electronic device 100 and retain the same within the interior of the case 50. Different embodiments are contemplated. In one embodiment, the device case includes lateral sidewalls 55, a lower wall 56, and an upper wall 57. These walls surround the perimeter of the rectangular electronic device 100 and the outer edges of the walls 55, 56, 57 include an inward ledge that retains the electronic device 100 therein. This secures the chassis of the device 100 while permitting access to the screen thereof through an open upper surface 60 of the device case 50. Depressible buttons 40 may be provided along the walls to facilitate depressing buttons or switches along the sides of the electronic device, depending on the make and model of the device 100 and the design of the case 50.

Extending between the device case 50 and the device mount 10 is an elongated tether 80. The tether 80 extends between the lower end 16 of the device mount 10 and a lower end 56 of the device case 50. Within the device mount 10 and referring now to FIG. 6, the tether 80 is furthermore supported on a retractable spool 65 within an enclosure 66 disposed within the device mount 10. The enclosure 66 of the device mount 10 is disposed between the interior surface 18 and the rear wall 19 of the device mount 10. The spool 65 is retractable and preferably comprises a ratchet and pawl mechanism 67 to operably lock the spool 65 after the tether 80 has been extended a desired amount while the electronic device 100 is in use. The spool 65 then can be unlocked and the spool 65 draws the tether 80 thereonto when the device case 50 and electronic device 100 are re-mounted on the device mount 10.

The spool 65 is a rounded member mounted on an axle and is freely rotatable therearound. Biasing the spool 65 is a torsion spring 68 along the axle that biases the spool 65 in the retraction direction. That is, in the direction to draw the tether 80 onto the spool 65 after the tether 80 has been extended. In one embodiment, an additional ratchet and pawl mechanism 67 is utilized in conjunction with the spool 65 to operably lock the spool 65 in a particular state after the tether 80 has been extended. This eliminates tension on the tether 80 after the device case 50 has been withdrawn from the device mount 10. The ratchet and pawl mechanism 67 can then be released, allowing the torsion spring 68 to bias the spool 65 and draw the tether 80 onto the spool 65 as the device case 50 is mounted on the device mount 10. The spool 65, torsion spring 68, and ratchet and pawl mechanism 67 are mounted within an enclosure 66 along the rear of the device mount 10. These elements are internally supported within the device mount. The tether 80 extends through an aperture 46 along the base 16 of the device mount.

In addition to a retractable spool 65, the device mount 10 further comprises a battery power supply 300 disposed therein. The battery power supply 300 is a rechargeable battery pack that is adapted to recharge the electronic device 100 when the electronic device 100 is positioned in the device case 50, and the device case 50 is mounted within the device mount 10. The battery power supply 300 is an equal or larger battery that can charge the battery of the electronic device 100, thereby extending operational periods between necessary charges. The device mount 10 therefore comprises a connector to connect a charging jack thereto, whereby the jack is connected to a wall outlet or similar power source to recharge the battery power supply 300 therein.

In order to charge the electronic device 100 using the battery power supply 300, the device mount 10 further comprises an electrical connector 200 adapted to couple to the electronic device 100 when the electronic device 100 is supported by the device case 50 and when the device case 50 is positioned within the device mount 10. The connector 200 is electrically connected to the battery power supply 300 of the device mount 10 and the electrical connecter 200 is disposed along the lower end 16 of the device mount 50. The type of connector 200 will vary depending on the type of electronic device 100 designed to be carried by the assembly. Several embodiments are provided for securing the device case 50 to the device mount 10 while simultaneously connecting the electronic device 100 to the electrical connector 200.

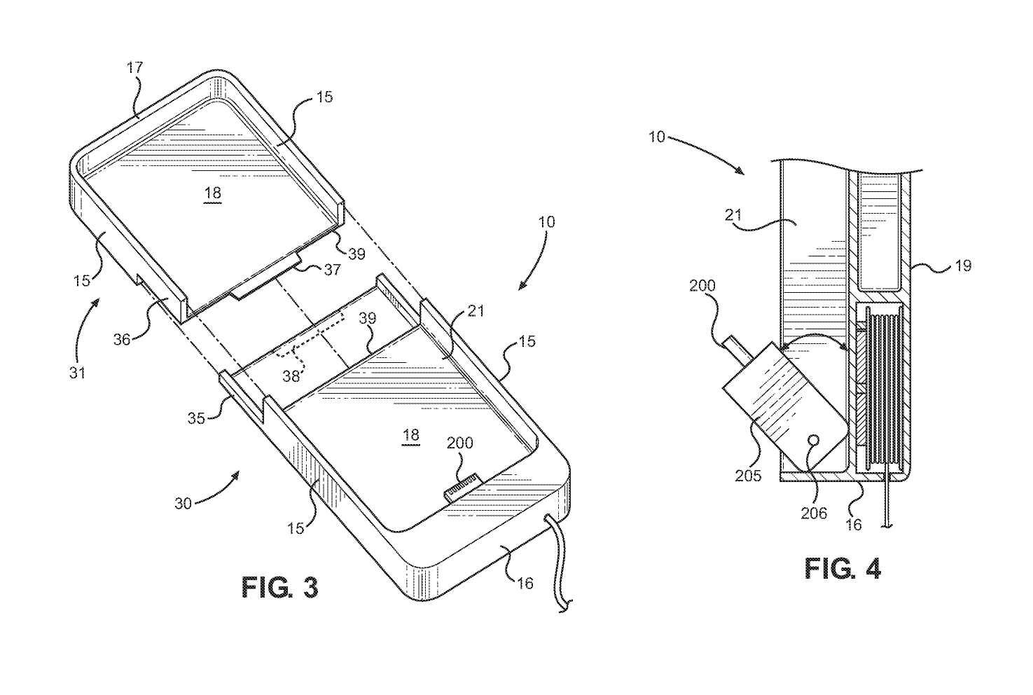

Referring to FIG. 3, there is shown an embodiment of the device mount 10 in which the device mount 10 comprises a separable upper half 31 and lower half 30. The upper half 31 and lower half 30 are removably connected along a line of connection 39 to allow the device mount 10 to separate and accommodate placement of the device case 50 within the device mount 10 while connecting the electronic device 100 to the electrical connector 200. In this embodiment, the two halves operably separate and connect, thereby extending the gap between the upper end 17 and lower end 16 of the device mount. This allows the device case 50 to more easily slide into the open interior of the device mount receptacle 21 and to connect the electronic device 100 to the electrical connector 200.

In one embodiment, the line of connection 39 between the two halves of the device mount 10 comprises a lap joint. A section 35 of the lower half 30 is overlapped by another section 36 of the upper half 31, whereafter the inner surface 18 of each half, the sidewalls 15, and the rear wall are all aligned and planar. This allows the two halves to form a singular receptacle 21, whereby the inner surfaces of the two halves align and form planar surfaces. Locking tabs 37 may additionally be provided between the two halves to secure the halves in a connected state. As shown in FIG. 3, one or more tabs 37 may engages a corresponding tab aperture 38, while holds the tab captive therein when engaged. The tab 37 can be separated when the user pulls the halves apart with sufficient force to overcome the friction of the joint. In some embodiments, the tab 37 may have a notch or ledge to improve the connection strength of the joint.

Referring now to FIG. 4, there is shown another embodiment of the device mount 10, whereby the electrical connector 200 is pivotably mounted along the lower end 16 of the device mount 10. The electrical connector 200 is mounted on a base 205 that is pivotably connected to a pivot pin 206 extending laterally across the lower end 16 of the device mount 10. This allows the base 205 and electrical connector 200 to pivot outward and outside of the receptacle 21 of the device mount 10. The pivoted position, as shown in FIG. 3, facilitates connection of the portable electronic device 100 to the electrical connector 200 when the device case 50 is positioned within the receptacle 21 of the device mount 10. The electrical connector 200 remains in electrical connection with the battery power supply 300 within the device mount in its stowed or pivoted position. In any embodiment, the electrical connector is electrically connected to the battery power supply and to any intermediate electronics that control the delivery of electrical power to the electronic device 100.

To ensure the device case 50 is retained within the device mount 10, several embodiments of the device mount 10 and case 50 are provided. As shown in FIG. 1, the device mount 10 may further comprise lateral tabs 25 that extend inwards along the upstanding sidewalls 15. The lateral tabs 25 extend inward along the open front surface 20 of the device mount 10 and inward from the outer edge 26 thereof. The lateral tabs 25 are adapted to be positioned over the device case 50 when the device case 50 is positioned within the receptacle 21 of the device mount 10. The tabs 26 are sized to allow insertion of the device case 50, whereby the tabs 25 may flex or the walls 15 of the device mount 10 may flex. Thereafter, the tabs 25 extend over the edges of the device case sidewalls 55 to secure the case therein.

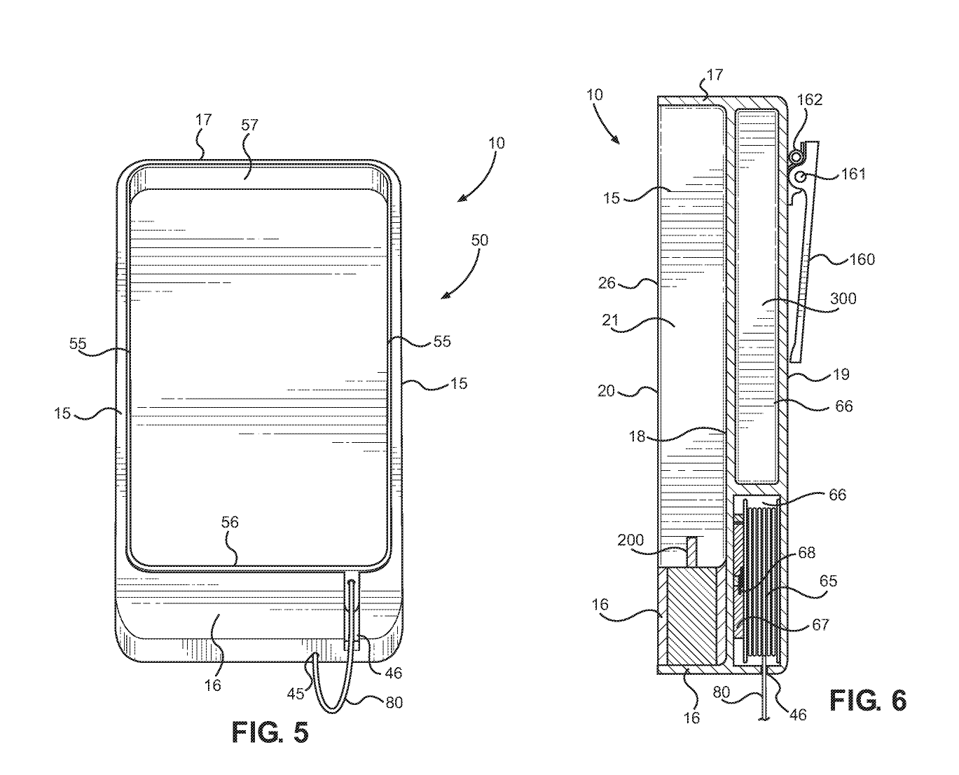

Referring to FIGS. 1 and 5, when the device case 50 is mounted in the device mount 10, the tether 80 extends from the lower end 16 of the device mount 10 and preferably engages a slot 46 therealong. The slot 46 extends through the lower portion 16 of the device mount 10 such that the tether 80 does not interfere with the placement of the device case 50 therein. The slot 46 allows the tether 80 to extend through an aperture 45 in the lower sidewall 16 of the device mount 10 and connect to the lower sidewall 56 of the device case 50 when the two are connected.

In addition or in lieu of lateral tabs 25, the device mount 10 may further comprise hook and loop fastener material 28 along the interior surface 18 thereof as shown in FIG. 2. The device case 50 may include corresponding hook and loop fastener material 68 along its rear wall, whereby the hook and loop material 28 of the device mount 10 and the hook and loop material 68 of the device case 50 are adapted to align and connect to one another when the device case 50 is positioned within the receptacle of the device mount 10.

Additionally, the device case 50 may further comprise a strap 90 or retainer that extends across the open upper thereof to secure the electronic device 100 within the device case 50. The strap 90 prevents the electronic device 100 from separating from the device case 50, whereby the strap 90 may extend laterally across the case 50 and connect to the outer edges 66 thereof. However, it may be preferred that the case sidewalls include an outer lip that extends over the chassis of the electronic device 100 and secures the electronic device within the case 50 without an additional strap element.

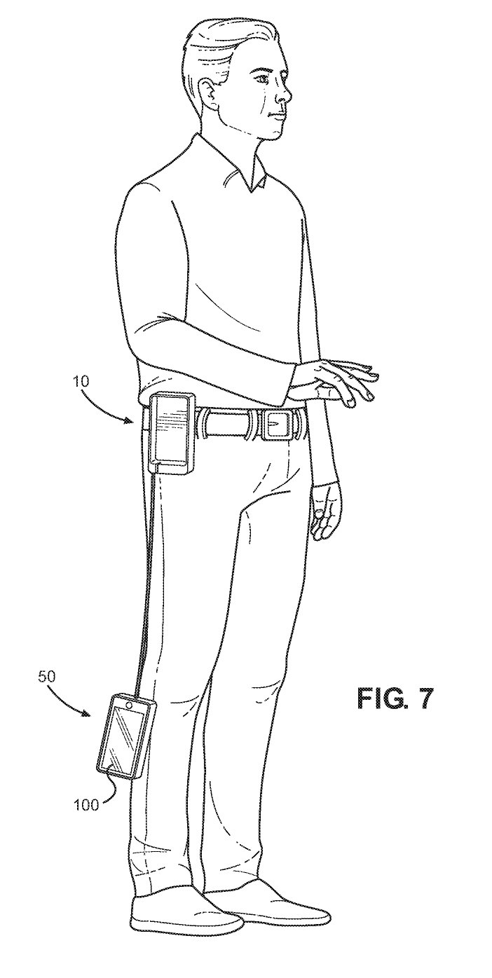

Referring now to FIGS. 6 and 7, the device mount 10 may further comprises a belt clip assembly along the rear wall 19 thereof. The device mount 10 is preferably a body-worn structure, wherefrom the device case 50 can be withdrawn and replaced. The tether 80 extends therebetween and can be used to retract the case 50 into the mount 10 and furthermore prevent the case 50 from falling to the ground while being handled. In one embodiment, the device mount 10 comprises a belt clip comprising a clip arm 160 mounted to a pivot pin 161 and biased in a closed position by a clip spring 162. The spring 162 acts on one end of clip arm 160, biasing a longer section of the clip arm 160 on an opposite side of the pivot pin 161. The clip assembly is useful for mounting the device mount 10 to a belt or body-worn structure.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A portable electronic device case assembly, comprising:
a device mount having a substantially rectangular shape with upstanding sidewalls, an open front surface, an interior surface, and a rear wall;
a device case that is adapted to support a portable electronic device, whereby the device case further comprises a substantially rectangular shape;
the upstanding sidewalls, interior surface, and open front surface of the device mount forming a receptacle adapted to receive the device case therein;
a tether extending between a lower end of the device mount and a lower end of the device case;
whereby the tether is supported on a retractable spool within an enclosure disposed within the device mount, the enclosure being disposed between the interior surface and the rear wall of the device mount;
a battery power supply disposed within the device mount;
the device mount further comprising an electrical connector adapted to couple to the portable electronic device when the portable electronic device is supported by the device case and when the device case is positioned within the device mount; and
wherein the connector is electrically connected to the battery power supply of the device mount and the electrical connecter is disposed along the lower end of the device mount.

2) The portable electronic device case assembly of claim 1, wherein the retractable spool further comprises:
a spool and a return spring to bias the spool;
whereby the return spring biases the spool so the tether is tensioned and biased to return on the spool.

3) The portable electronic device case assembly of claim 2, wherein the retractable spool further comprises a ratchet and pawl mechanism to operably lock the spool in a static state when the tether is extended.

4) The portable electronic device case assembly of claim 1, wherein:
the battery power supply is disposed between the interior surface and the rear wall of the device mount.

5) The portable electronic device case assembly of claim 1, wherein:
the device mount has an upper half and a lower half;
whereby the upper half and lower half are removably connected along a line of connection to facilitate placement of the device case within the receptacle of the device mount and connection of the portable electronic device to the electrical connector.

6) The portable electronic device case assembly of claim 1, wherein:
the electrical connector is pivotably mounted along the lower end of the device mount to facilitate connection of the portable electronic device to the electrical connector when the device case is positioned within the receptacle of the device mount.

7) The portable electronic device case assembly of claim 1, wherein:
the device mount further comprises lateral tabs along the upstanding sidewalls thereof;
the lateral tabs extending inward along the open front surface of the device mount;
whereby the lateral tabs are adapted to be positioned over the device case and secure the device case within the receptacle of the device mount when the device case is positioned therein.

8) The portable electronic device case assembly of claim 1, wherein:
the device mount further comprises hook and loop fastener material along the interior surface thereof;
wherein the device case further comprises corresponding hook and loop fastener material along a rear wall of the device case; and
whereby the hook and loop material of the device mount and the hook and loop material of the device case are adapted to align and connect when the device case is positioned within the receptacle of the device mount.
